(19) United States
(12) Patent Application Publication
(10) Pub. No.: US 2012/0166419 A1
(43) Pub. Date: Jun. 28, 2012

(54) METHOD, SYSTEM AND PROGRAM FOR CACHE CONTROL IN DATABASE

(75) Inventors: Miki Enoki, Kanagawa (JP); Yohsuke Ozawa, Kanagawa (JP); Hiroshi Horii, Kanagawa (JP)

(73) Assignee: INTERNATIONAL BUSINESS MACHINES CORPORATION, ARMONK, NY (US)

(21) Appl. No.: 13/251,131

(22) Filed: Sep. 30, 2011

(30) Foreign Application Priority Data
Sep. 30, 2010 (JP) JP2010-221450

(51) Int. Cl. G06F 17/30

(52) U.S. Cl. 707/714; 707/741; 707/E17.017; 707/E17.002

(57) ABSTRACT

A system, a program product and an associated method is provided for data processing management in a computing environment having at least a processor. The method comprises creating in the memory an invalidation index having a plurality of rows, each row further comprising a search key field, an ID list field for IDs of records associated with the database, and a count value field. Every time a new reference query is received the processor searches for a row in said invalidation index with an already created search key and then decreases count value of a counter when a match is found and when a match is not found creating a new search key and a new row in an associated invalidation index for said new key.

### CROSS REFERENCES

This application claims priority from foreign filed application JP 2010-221450 filed Sep. 30, 2010. That application is incorporated by reference herein.

### BACKGROUND OF THE INVENTION

1. Field of the Invention

This invention relates generally to database processing in a computer system and more particularly to a technique for achieving fast data access by caching data from a database.

2. Description of Background

Data caching is used conventionally in order to speed up the rate of a database search. Cache invalidation is a process by which entries in a cache are deleted and is required in a number of instances. To reduce the effect of cache invalidation on data integrity as well as on the speed of the data to be processed, cache entry to be invalidated can be determined by means of an index. This technique, however, requires additional memory for saving the index, which in turn results affects the overall memory capacity available for a cache.

To resolve this problem, the prior art uses methods wherein the data included in a particular index can be limited. Techniques for limiting data to be included on an index for use in accessing a database are well known in the art. Alternatively, the index can be hash-partitioned to alleviation the problem. In each of these cases, the result is the broadening of the scope of cache invalidation broadens which in turn also causes the cache hit ratio to drop in turn. In addition, similar techniques can be utilized during cache maintenance such as during data updates. In other methods, cache is examined according to an access pattern and evicted or deletion when cache has exceeded a predetermined size. More specifically, by not including an attribute that is not required for an access pattern into the cache when partitioning cache space based on access pattern, the technique provides an effect of wasting less cache space than when all relevant attributes are included.

The prior art techniques listed above, however, each have different shortcomings. In general, each of the proposed solutions still leaves memory space problems as memory in each case is limited because of resource limitation. Consequently, it is desirable to efficiently generate an invalidation index for accessing a cache in a database within a limited amount of memory space. In addition, it is desirable to reduce the influence of cache invalidation on a hash-partitioned invalidation index.

### SUMMARY OF THE INVENTION

The shortcomings of the prior art are overcome and additional advantages are provided through the provision of a system, a program product and an associated method of data processing management in a computing environment having at least a processor, a database accessible by a date cache and a memory is provided. The method comprises the steps of creating in the memory an invalidation index having a plurality of rows, each row further comprising a search key field, an ID list field for IDs of records associated with said database, and a count value field and creating a search key associated with different data queries. Every time a new reference query is received the processor searches for a row in said invalidation index with an already created search key and then decreases count value of a counter when a match is found and when a match is not found creating a new search key and a new row in an associated invalidation index for said new key. Once this is done, information is stored which is associated with said new key in ID of a record and said ID list field.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is an illustration of one embodiment of the present invention showing a computing environment comprised of sub-environments such as the Internet and the connection of client computers to an application server in such sub-environments;

FIG. 2 is an illustration of a hardware configuration of a client computer such as used in the embodiment of FIG. 1;

FIG. 3 is an illustration of a hardware configuration of an application server such as used in conjunction with the embodiment of FIG. 1;

FIG. 4 is a functional block diagram as per one embodiment of the present invention;

FIG. 5 is an example of database records such as used as per one embodiment of the present invention;

FIG. 6 is an example of data cache entries such as used as per one embodiment of the present invention;

FIG. 7 shows an example of entries of an invalidation index as per one embodiment of the present invention;

FIG. 8 is a schematic flowchart as per one embodiment of the present invention illustrating a process to create Index_U1_WeightHashMap;

FIG. 9 is a flowchart illustration of a process performed on issuance of an update query as per one embodiment of the present invention;

FIG. 10 is a flowchart illustration of a process as performed by one embodiment of the present invention showing issuance of a reference query;

FIG. 11 is a flowchart illustration as per one embodiment of the present invention showing splitting of an entry of an invalidation index; and

FIG. 12 is an illustrates of one embodiment of the present invention further showing an example of an entry where an invalidation index is split.

### DESCRIPTION OF THE INVENTION

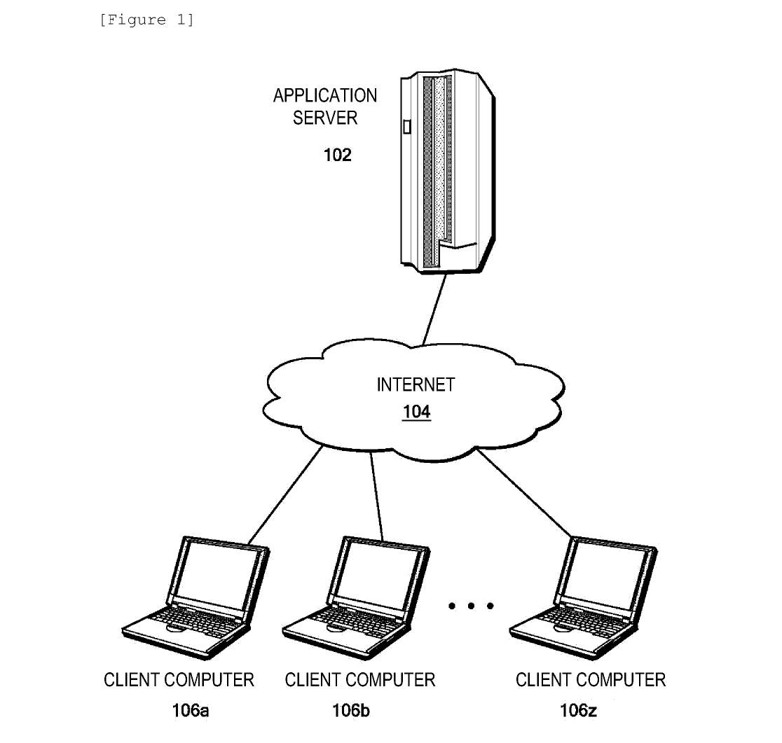

FIGS. 1 through 12 in conjunction with the discussions as will be provided below describe different embodiments of the present invention. The discussion of FIGS. 1 through 12 will be provided in reference to a computing environment having at least one processor in processing communication with a data cache and a memory is used. Databases can be formed in the cache or the memory or both and be accessible to the processor. In one embodiment, the cache and the memory are also in processing communication with one another. For ease of reference, some of the key numerals discussed in the figures will be presently provided for convenience.
102 application server
302 communication interface
306 CPU
308 main memory
310 hard disk drive
402 application program
404 database management system
406 database
408 data cache
410 invalidation index

The present invention is designed to address many of the shortcomings of the prior art such as memory constraints as discussed in the background section. For example, in one embodiment as will be discussed in detail, the problems associated with maintenance issues of a cache hit ratio with an invalidation index of limited size is addressed based on information on frequencies of updates and references. In one embodiment, this has been achieved by partitioning the index in sections and for each section of a hash-partitioned index, sections with a high ratio of updates are combined and a section with a high ratio of references is further split so as to make the sections less affected by invalidation, in expectation of an improved cache hit ratio compared to when the index is equally partitioned into k portions (i.e., hash-partitioned).

In another embodiment, a system is provided that first creates a table for an invalidation index called INDEX_U1_HashMap, for example, in a memory. The INDEX_U1_HashMap includes a field to store a hash value generated from a search condition in a search statement, a field to store an ID of a record that matches the search condition, and a count field. Since multiple records hit for a certain search condition in general, the record ID field can include more than one ID. The count field is incremented in response to data being updated with a corresponding search condition, that is, in response to invalidation of cache for a record that matches the search condition, and decremented for a data reference with a corresponding search condition. Although not limitative, increment typically means increasing a value by one and decrement means decreasing a value by one.

Upon elapse of a predetermined time period, the system according to the invention checks the count field of the INDEX_U1_HashMap, and merges rows of the table if their count-field values are greater than a certain threshold, and splits a row(s) so as to fill in rows that have become blank due to merging starting with a row having the smallest count value.

The value in the count field being greater than a predetermined threshold indicates that the row has a high frequency of updates, so the number of rows in the INDEX_U1_HashMap is reduced by merging rows. This means an appropriate number of rows are kept in the invalidation index table within limited memory. Along with update, an entry in the corresponding ID field is flushed.

On the other hand, a small value in the count field typically means a high frequency of references, so row splitting makes the rows of the invalidation index less affected by invalidation. That is, with a row split, IDs included in rows affected by a data update performed for a certain search condition are reduced and cache hit ratio will improve.

A table for INDEX_U1_HashMap that has undergone such row merging or splitting based on the value in the count field will be also called INDEX_U1_WeightedHashMap.

According to the present invention, an invalidation index table is provided with a count field, and a weight for each row is calculated based on the numbers of data updates and reference queries for the row. Rows of the invalidation index are merged if the value of their count field is greater than a certain threshold, and a row(s) of the invalidation index is split so as to fill in rows that have become blank due to merging, starting with the row having the smallest count value, thereby generating a weighted invalidation index. This provides the effect of keeping the invalidation index at an appropriate size and also improving cache hit ratio for reference accesses.

An embodiment of the invention will be described below with reference to drawings, throughout which the same reference numbers denote the same elements unless otherwise specified. Note also that what is described below is an embodiment of the invention and does not intend to limit the invention to contents set forth in the embodiment.

In FIG. 1, an application server 102 which also has database server functions receives requests from multiple client computers 106a, 106b, . . . ,106z via the Internet 104 according to a protocol such as HTTP. In the system of FIG. 1, a user of a client computer logs into the application server 102 through a web browser over lines of the Internet 104. Specifically, the user types a predetermined URL on the web browser to display a specific page. The user may use a dedicated client application program to log into the application server instead of using a web browser.

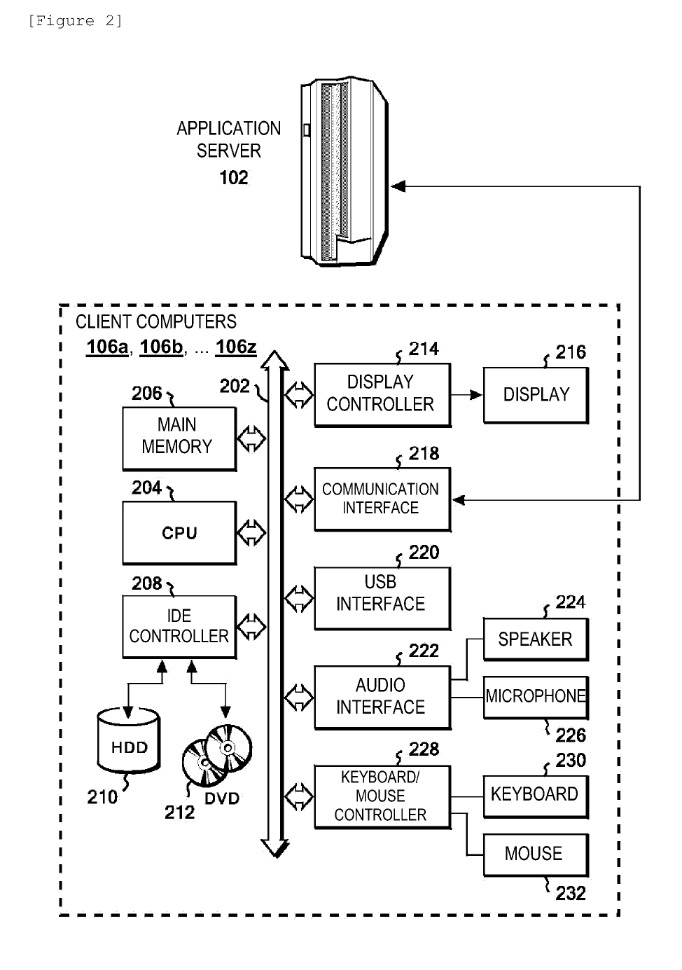

Referring now to FIG. 2, a hardware block diagram for the client computers shown in FIG. 1 as reference numbers 106a, 106b, . . . and 106z will be described. In FIG. 2, a client computer includes a main memory 206, a CPU 204, and an IDE controller 208, which are connected to a bus 202. Further connected to the bus 202 are a display controller 214, a communication interface 218, a USB interface 220, an audio interface 222, and a keyboard/mouse controller 228. To the IDE controller 208, a hard disk drive (HDD) 210 and a DVD drive 212 are connected. The DVD drive 212 is used for installing a program from a CD-ROM or a DVD as desired. To the display controller 214, a display device 216 with an LCD screen is preferably connected. On the display device 216, application screens are displayed through the web browser.

To the USB interface 220, devices such as an expansion hard disk can be connected as desired. A keyboard 230 and a mouse 232 are connected with the keyboard/mouse controller 228. The keyboard 230 is used for entering key data or a password for a search.

The CPU 204 may be any CPU on a 32- or 64-bit architecture, for example, such as Pentium (a trademark of Intel Corporation) 4 from Intel, Core (a trademark) 2 Duo, and Athlon (a trademark) from AMD.

In the hard disk drive 210, at least an operating system and a web browser running on the operating system (not shown) are stored, and the operating system is loaded into the main memory 206 at system startup. The operating system may be Windows XP (a trademark of Microsoft Corporation), Windows Vista (a trademark of Microsoft Corporation), Windows (a trademark of Microsoft Corporation) 7, Linux (a trademark of Linus Torvalds), and the like. The web browser may be any suitable browser, such as Internet Explorer from Microsoft Corporation and Mozilla FireFox from Mozilla Foundation.

The communication interface 218 communicates with the application server 102 according to Ethernet (a trademark) protocol or the like utilizing TCP/IP communication functions provided by the operating system.

FIG. 3 is a schematic block diagram showing a hardware configuration of the application server 102. As shown in FIG. 3, client computers 106a, 106b, . . . ,106z are connected with the communication interface 302 of the application server 102 over the Internet 104. The communication interface 302 is further connected with the bus 304, to which a CPU 306, a main memory (RAM) 308, and a hard disk drive (HDD) 310 are connected.

Although not shown, a keyboard, a mouse, and a display may also be connected with the application server 102, whereby a maintenance person can perform overall management and maintenance tasks for the application server 102.

In the hard disk drive 310 of the application server 102, an operating system and a correspondence table between user IDs and passwords for managing logins by the client computers 106a, 106b, . . . and 106z are stored. The hard disk drive 310 further stores software for having the application server 102 function as a web server, such as Apache, Java EE to realize a Java virtual environment, and an application program 402 according to the present invention described later that runs on the Java virtual environment. These programs are loaded into the main memory 308 for operation upon the application server 102 being started up. This allows the client computers 106a, 106b, . . . , 106z to access the application server 102 according to the TCP/IP protocol.

In the hard disk drive 310 of the application server 102, a database management system 404 and a database 406 described below are also stored.

The application server 102 may be any model, such as IBM (a trademark of International Business Machines Corporation) System X, System i, and System p that can be available from International Business Machines Corporation. Operating systems that can be used with such servers include AIX (a trademark of International Business Machines Corporation), UNIX (a trademark of The Open Group), Linux (a trademark), and Windows (a trademark) 2003 Server.

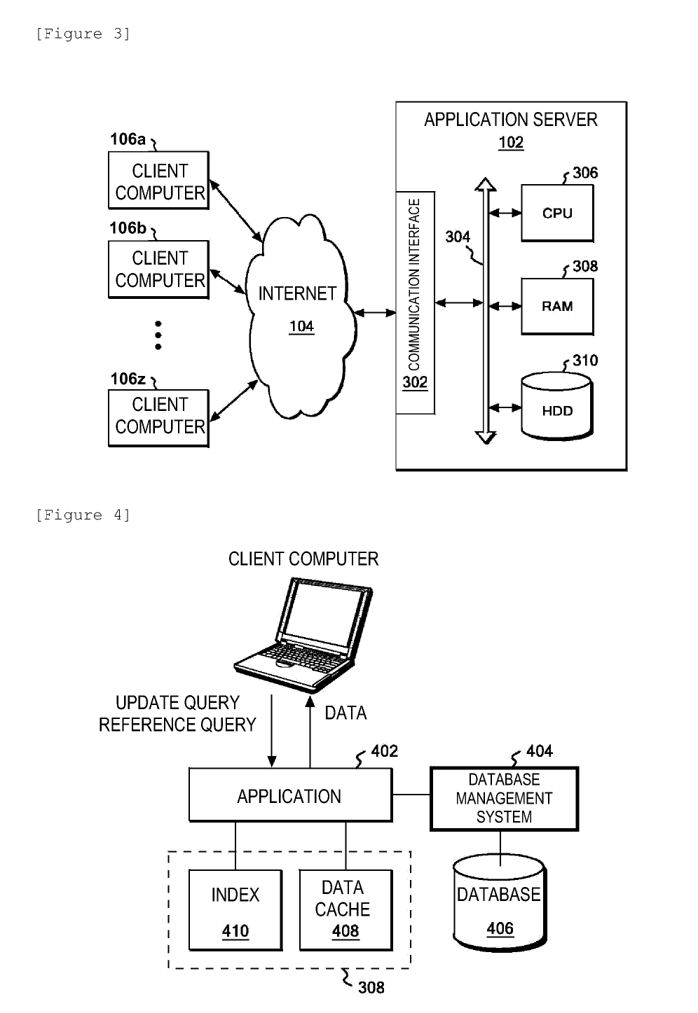

Referring now to FIG. 4, the functional configuration of the present invention will be described. The application program 402 is an application program for O/R mapping written in Java (R). O/R mapping is a feature for mapping (or association) between objects handled in an object-oriented language, such as Java (R), and records of a relational database. By way of example and not limitation, the description herein assumes an online shopping site.

The application program 402 issues an inquiry to the database management system 404. The database management system 404 is preferably a relational database, e.g., IBM (R) DB2.

A database 406 managed by the database management system 404 is saved in the hard disk drive 310 and has such records as shown in FIG. 5. It should be understood that FIG. 5 is merely an example and the database 406 actually includes more records.

The application program 402 is provided with a data cache 408 and an invalidation index (hereinafter, sometimes called just “index”) 410 in the main memory 308, and stores data retrieved from the database 406 via the database management system 404 in the data cache 408. FIG. 6 shows an example of entries in the data cache 408. It should be understood that FIG. 6 is merely an example and the data cache 408 actually includes more entries.

The application program 402 receives a reference query or update query for data in the database 406 from a client computer. For a reference query, the application program 402 returns data that satisfies a condition. If data that satisfies the condition is present in the data cache 408, the data in the data cache 408 is returned to the client computer. If no data that satisfies the condition is found in the data cache 408, the application program 402 makes an inquiry to the database management system 404.

For an inquiry, the application program 402 uses an ID of data in the data cache 408 that is stored in an entry of the invalidation index 410 to rapidly access the data in the data cache 408.

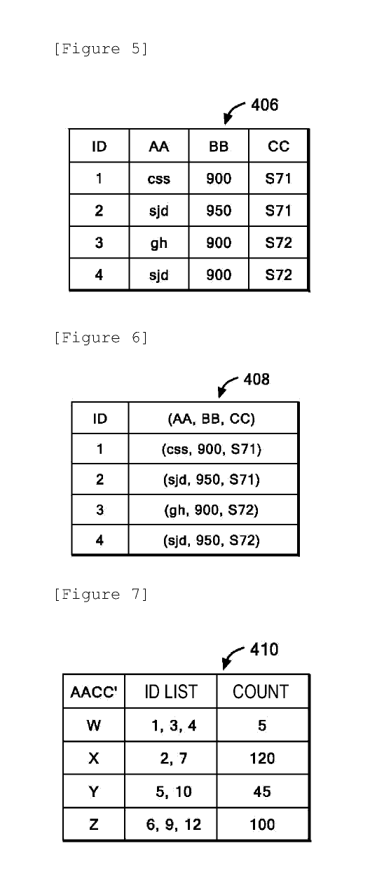

FIG. 7 shows an example of structure and entries of the invalidation index 410. As shown in the figure, the invalidation index 410 has a field, AACC′, to store hash values for search conditions, a field for ID numbers of records in the database 406, and a field for keeping count. A value to be stored in the search condition hash field is generated from a search condition following ‘where’ in a SQL statement of a query. The ID number field may contain multiple ID numbers for records of the database 406 that meet a search condition. The count field is controlled by application program 402 such that it is incremented by one for an update access and decremented by one for a reference access.

When the application program 402 receives an update query for the database 406 from a client computer, it makes an update inquiry to the database management system 404 and also deletes corresponding data in the data cache 408. This is because the corresponding data in the data cache 408 will become invalid after updating.

The data cache 408 and the invalidation index 410 are reserved in the main memory 308 for each application program, so if multiple application programs are running on the application server 102, the amount of main memory 308 that can be allocated to each application program is limited. The present invention is intended to efficiently utilize the invalidation index 410 within such a limited memory capacity.

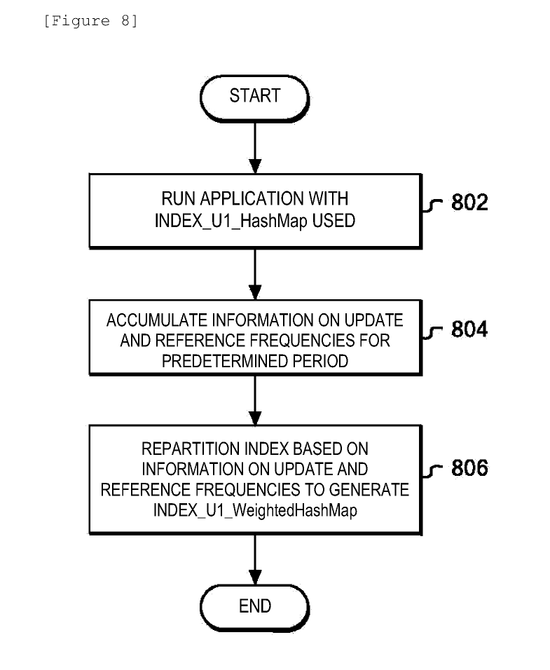

Now, processing on the invalidation index 410 performed by the application program 402 will be described in greater detail with reference to FIG. 8 and the subsequent drawings.

At step 802 in the flowchart of FIG. 8, the application program 402 executes processing with INDEX_U1_HashMap used. INDEX_U1_HashMap refers to the invalidation index 410 having the table structure shown in FIG. 7, and an invalidation index 410 that is created initially is specifically called INDEX_U1_HashMap in this embodiment.

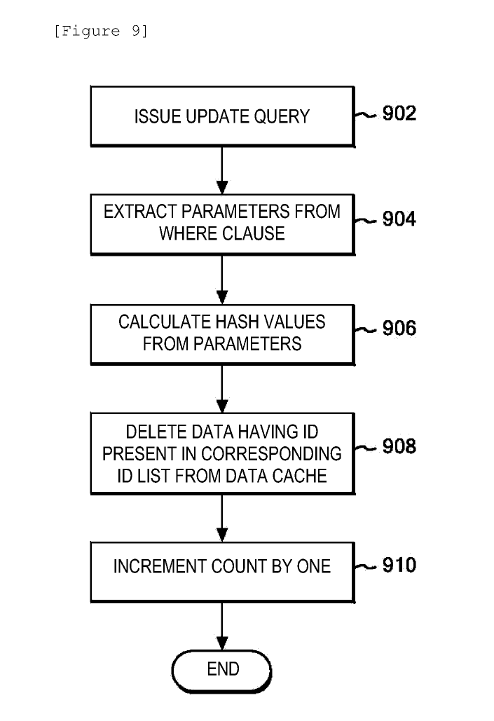

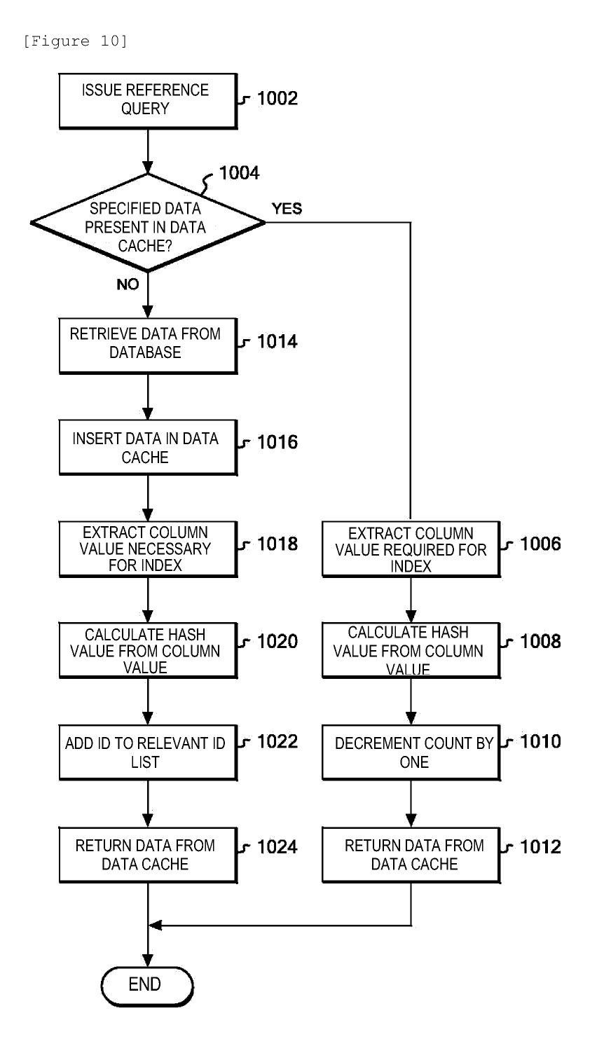

Typical processing performed by the application program 402 at this step is reception of an update or reference query to the database from a client computer. Details of processing on reception of an update or reference query will be described later with reference to the flowcharts of FIGS. 9 and 10.

At step 804, the application program 402 executes processing for a predetermined time period to accumulate information on frequencies of updates and references. The predetermined time period as referred to here may be literally a predefined amount of time or reception of a predefined number of update or reference queries.

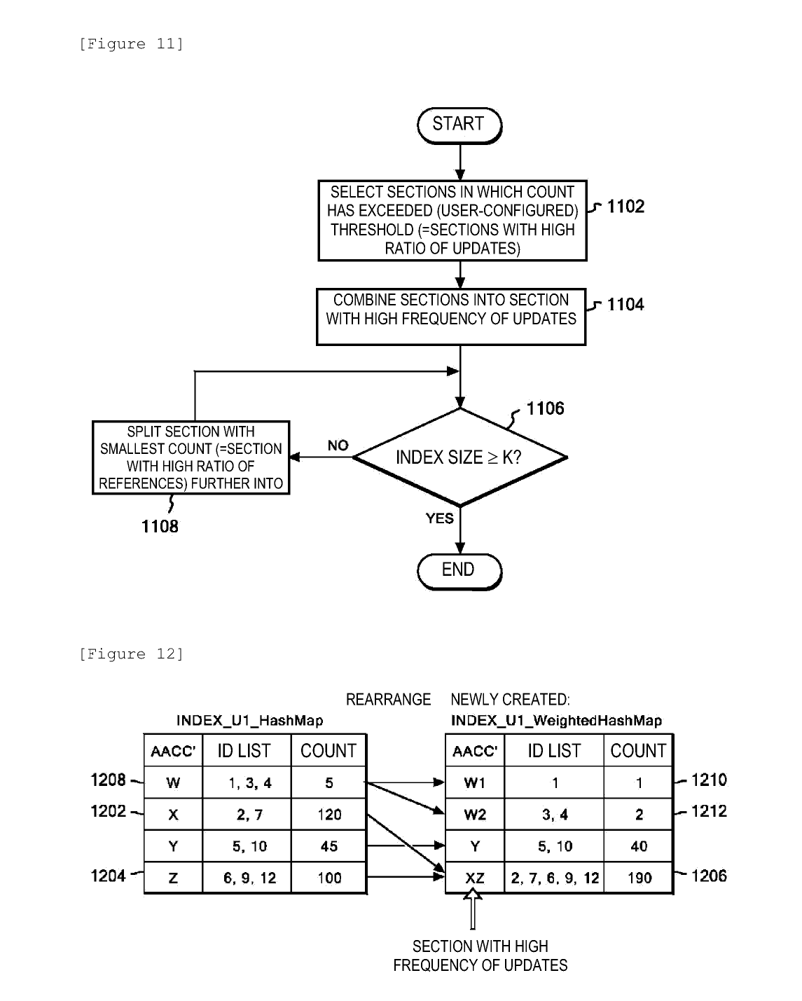

At step 806, the application program 402 reparations the invalidation index based on the information on update and reference frequencies to generate INDEX_U1_WeightedHashMap. The index repartitioning will be described later with reference to the flowchart of FIG. 11. Preferably, INDEX_U1_WeightedHashMap is not a separate entity from INDEX_U1_HashMap: this embodiment uses the designation “INDEX_U1_WeightedHashMap” instead of “INDEX_U1_HashMap” upon performing invalidation index repartitioning on INDEX_U1_HashMap.

The creation of INDEX_U1_WeightedHashMap shown in FIG. 8 may be repeated periodically or in response to a certain event. Note that INDEX_U1_HashMap at step 802 is actually INDEX_U1_WeightedHashMap that was created previously.

Referring now to the flowchart of FIG. 9, processing performed on receiving an update query by the application program 402 from a client computer will be described.

At step 902, a client computer issues an update query and the application program 402 receives the update query. For example, an update query may be represented by a SQL statement like:

UPDATE ITEM SET CC=‘S72’ WHERE AA=‘css’ AND CC=‘S71’.

At step 904, the application program 402 extracts parameters from the WHERE clause. In the example above, “AA=‘css’ AND CC=‘S71’” represents parameters in the WHERE clause.

At step 906, the application program 402 calculates hash values from the WHERE-clause parameters. This embodiment calculates a hash value in the following manner, though the present invention is not limited thereto. When converting ‘css’ and ‘S71’ to numerical values according to ASCII character codes, they will be 678383 and 512317, respectively. The two values are concatenated into 678383512317, to which a hash function is applied to obtain a hash value. The hash function used here can be most simply a modulo operation with an appropriate prime number.

Using an appropriate function F( )on the example invalidation index of FIG. 7 in this embodiment results in:

W=F(‘css’,‘S71’)

X=F(‘sjd’,‘S71’)

W=F(‘gh’,‘S72’)

W=F(‘sjd’,‘S72’)

Hash values thus calculated are stored in the AACC′ field of FIG. 7. As this embodiment assumes a search condition of a fixed format like “AA=?? AND CC=??” as the WHERE clause, a hash value is easy to calculate. Such an assumption is possible because a web site for online shopping and the like defines and exclusively uses a number of fixed query formats.

At step 908, the application program 402 deletes from the data cache 408 data corresponding to an ID present in the ID list field in a row of INDEX_U1_HashMap that has the calculated hash value. This is done because the corresponding data in the data cache 408 has become invalid due to update of data corresponding to the ID performed for the update query. In conjunction with it, data on the ID in the ID list field in the row of INDEX_U1_HashMap is flushed.

At step 910, the application program 402 increments by one the value of the count field in the row of INDEX_U1_HashMap that has the calculated hash value, and terminates the process. It is also possible that other updates affect the invalidation index. In that case, the invalidation index may be maintained such as by deleting entries in any row that has been affected.

Referring now to the flowchart of FIG. 10, processing performed on reception of a reference query by the application program 402 from a client computer will be described.

At step 1002, a client computer issues a reference query and the application program 402 receives the reference query. For example, a reference query may be expressed by a SQL statement like:

SELECT*FROM ITEM WHERE AA=‘css’ AND CC=‘S71’

At step 1004, the application program 402 determines whether data specified by the search condition in the reference query is present in the data cache. If the data is present in the data cache, application program 402 extracts a column value required for the invalidation index at step 1006. This is substantially the same process as that described in connection with step 904, extracting a parameter from the WHERE clause in the reference query.

At step 1008, the application program 402 calculates a hash value from the column value. This is substantially the same process as that described above in connection with step 906.

At step 1010, the application program 402 decrements by one the count value of a row in the invalidation index 410 (INDEX_U1_HashMap) that has the hash value calculated at step 1006 in its hash value field.

At step 1012, the application program 402 retrieves and returns data corresponding to the ID value specified in the reference query from the data cache 408, and terminates the process.

Returning to step 1004, if the application program 402 determines that the data specified by the search condition in the reference query is not present in the data cache, the application program 402 makes an inquiry to the database management system 404 at step 1014 to retrieve the data specified by the search condition in the reference query from the database 406.

At step 1016, the application program 402 inserts the data retrieved from the database 406 into the data cache 408.

At step 1018, the application program 402 extracts a column value that is required for the invalidation index. This is substantially the same process as that described in connection with step 904, extracting parameters from the WHERE clause in the reference query.

At step 1020, application program 402 calculates a hash value from the column value. This is substantially the same process as that described above in connection with step 906.

At step 1022, if there is any row in the invalidation index 410 that has the hash value generated at step 1020, the application program 402 stores the ID value for the data inserted into the data cache 408 at step 1016, in the ID list field of the row. If there is no row in the invalidation index 410 that has the hash value generated at step 1020, the application program 402 creates a blank row in the invalidation index 410, stores the hash value calculated at step 1020 in the hash value field of the row, and stores the ID value for the data inserted into the data cache 408 at step 1016 in the ID list field of the row.

At step 1024, the application program 402 retrieves and returns data in the data cache 408 that corresponds to the ID value added to the ID list of the row in the invalidation index 410 (INDEX_U1_HashMap) at step 1022, and terminates the process.

Referring to the flowchart of FIG. 11, processing for the application program 402 to split or merge rows of the invalidation index 410 (INDEX_U1_HashMap) according to certain conditions will be now described.

At step 1102, the application program 402 selects sections in which the count has exceeded a threshold value set by a user among rows of the invalidation index 410 (INDEX_U1_HashMap), namely sections with a high frequency of updates. In an example of INDEX_U1_HashMap shown in FIG. 12, rows having hash values X and Z in the AACC′ field represent such sections.

At step 1104, the application program 402 performs a process to combine the sections with a high frequency of updates selected at step 1102 together. Specifically, this process merges a row 1202 having the hash value of X in the AACC′ field and a row 1204 having the hash value of Z into a row 1206 of INDEX_U1_WeightedHashMap in the example of FIG. 12. The designation “XZ” in the AACC′ field of the row 1026 means either of the hash values X or Z corresponds to this row. To realize this, a function F₁( )that makes XZ=F₁ (AA field value, CC field value) for IDs=2, 7, 6, 9, 12 is prepared and the hash value field of the row 1206 is marked to specify that function F₁( )be used instead of F( )for hash calculation. Alternatively, a function for use in hash calculation may be stored in the hash value field.

In a row thus merged, ID lists from the original rows are also merged. The count value need not to be inherited from the original rows and may be set to zero. Although merging of more than two rows is possible, a separate threshold may be established and if the total count value of rows in question exceeds the threshold, further merging is not performed and a third or further row is merged with another row.

At step 1106, the application program 402 determines whether the row size of the invalidation index 410 (INDEX_U1_HashMap) is equal to or greater than K, i.e., the number of rows allowed in the invalidation index. If the row size is equal to K or greater, it is not permitted to add further rows to the invalidation index 410 and thus the process simply terminates.

If it is determined at step 1106 that the row size of the invalidation index 410 is less than K, the process proceeds to step 1108, where the application program 402 splits a section with the smallest count, that is, a section with the highest ratio of references, further into two sections. In FIG. 12, a row 1208 represents such a section. This splitting is done by using a modulo with a prime number that is different from the one used at step 906 as a hash function to sort IDs in the ID list of the target row 1208 of INDEX_U1_HashMap, for example. More specifically, with reference to numerical values generated from data as described in step 906, data corresponding to IDs=1, 3, and 4 have the same hash value with the original hash function. The target row 1208 in INDEX_U1_HashMap is split into a row 1210 for ID=1 and a row 1212 for IDs=3 and 4 in INDEX_U1_WeightedHashMap with a hash function using a different modulus.

More specifically, use of the aforementioned function F( )results in the same hash value W for IDs 1, 3, and 4:

W=F(‘css’,‘S71’)//ID=1

W=F(‘gh’,‘S72’)//ID=3

W=F(‘sjd’,‘S72’)//ID=4,

whereas another function F₂( )is prepared so that different hash values are obtained for a group with ID=1 and a group with IDs=3 and 4 like:

W1=F2(‘css’,‘S71’)//ID=1

W2=F2(‘gh’,‘S72’)//ID=3

W2=F2(‘sjd’,‘S72’)//ID=4.

The hash value fields of the rows 1210 and 1212 are marked to specify that F₂( )be used instead of F( )for hash calculation. Alternatively, a function for use in hash calculation may be stored in the hash value field. In rows 1210 and 1212 after splitting, their count values do not have to be inherited from the original row 1208 and the count may be set to zero upon splitting.

In general, the count value field may be cleared to zero and counting may be restarted when INDEX_U1_WeightedHashMap is generated from INDEX_U1_HashMap.

The row splitting at step 1108 is repeated until it is determined that the size of the invalidation index has reached K, the limit, at step 1106.

With rows of the invalidation index 410 thus split, only one row of the invalidation index 410 will be invalidated at a time for an update inquiry, which can reduce data entries in the data cache that are invalidated for an update query and improve cache hit ratio, thereby speeding up database inquiry.

Calculation for the hash field of the invalidation index 410 need not necessarily use a hash function. Instead, a numerical value obtained by converting an expression following the WHERE clause may be sorted into equally spaced ranges.

Additionally, although the above-described embodiment increments the value of the count value field by one for an update query and decrements by one for a reference query, this is not limitation and variations shown below may be adopted. That is, the result of any of the following calculations is stored in the count value field:
(1) the number of references×(the number of references/the number of references)
In this case, a larger value means higher ratio and frequency of updates.
(2) cache hit ratio×the number of references×(the number of references/the number of updates)
This calculation incorporates difference in cache hit ratio in consideration of difference in application behavior.
(3) (the number of cache hits)×Cₕᵢₜ/{the number of updates×C_{update}+(the number of cache misses)×Cₘᵢₛₛ}
This calculation takes into consideration costs of cache hits and cache invalidation, where Cₕᵢₜ represents cost for a cache hit, C_{update} represents cost for cache invalidation, and Cₘᵢₛₛ represents cost for a cache miss.

Furthermore, although the embodiment above positions the database in the application server, a database server may be provided independently of the application server and the database may be positioned in the database server, which may be accessed by the application server.

The embodiment of the present invention has been described in the context of a particular hardware and software platform, those skilled in the art will recognize that the invention can be practiced on any computer hardware and platform.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of data processing management in a computing environment having at least a processor, a database accessible by a date cache and a memory; the method comprising the steps of:
creating in said memory an invalidation index having a plurality of rows, each row further comprising a search key field, an ID list field for IDs of records associated with said database, and a count value field;
creating a search key associated with different data queries; every time a new reference query is received said processor searching for a row in said invalidation index with an already created search key;
decreasing count value of a counter when a match is found and when a match is not found creating a new search key and a new row in an associated invalidation index for said new key;
storing information associated with said new key in ID of a record and said ID list field.

2. The method of claim 1; further comprising the step of repeating, within an available index size, a process to split a row of said invalidation index that has a smallest count value and that has said created search key into at a predetermined time according to a condition relating to the record values of said database.

3. The method of claim 2, further comprising the step of sorting ID values that have been stored in said ID list field of the split row according to the condition relating to record values.

4. The method of claim 3, further comprising storing in said search key fields of said new rows, different search key values that are calculated based on the ID values that are sorted and stored.

5. The method of claim 4, further comprising the steps of: creating a search key for said invalidation index based on a search condition of an update query; in response to finding an invalidation index that has said related created search key, invalidating data in data cache that corresponds to an ID stored in the ID list field of the row; and increasing said count value.

6. The method of claim 5, further comprising the step of: combining rows of said invalidation index that have the count value greater than a predetermined threshold into a new row at a predetermined time and joining ID values in the ID list fields of the rows together into an ID value.

7. The method of claim 6, further comprising calculating a search key corresponding to the ID value generated by joining; and storing the calculated search key in said search key field of said new row.

8. The method according of claim 7, wherein the step of increasing said count value increments the count value by one.

9. The method of claim 8, wherein the step of increasing or decreasing said count value is based on said processor calculating a value that is weighted based on numbers of data updates and reference queries for each row of the invalidation index and stores the value as said count value.

10. A computer program product, stored on a computer readable medium comprising a storage device, for accessing resources within a data processing network, said computer program product having instructions for execution by a computer having at least one processor, which, when executed by the computer, cause the computer to implement a method comprising:
preparing in a memory of said computer an invalidation index having a search key field, an ID list field for IDs of records in the database, and a count value field;
extracting a column value required for creating a search key based on data acquired in a reference query to said memory so as to create a search key for the invalidation index;
searching for a row of the invalidation index that has the created search key;
decreasing count value in response to finding a row of invalidation index that has the created search key;
creating a new row in the invalidation index in response to not finding a row of invalidation index that has the created search key; storing said created search key in said search key field of the new row, and storing an ID of a record of the database that matches a search condition of the reference query in said ID list field of the new row; and
repeating, within an available index size, a process to split a row of the invalidation index that has a smallest count value and that has the created search key into new rows at a predetermined time according to a condition relating to record values of the database, sort ID values that have been stored in the ID list field of the split row according to said condition relating to the record values, store the sorted ID values in the ID list fields of the new rows, and store, in the search key fields of the new rows, different search key values that are calculated based on the ID values sorted and stored.

11. The program product of claim 10, further comprising the steps of:
creating a search key for said invalidation index based on a search condition portion of an update query; and
in response to finding a row of the invalidation index that has said created search key, invalidating data in the data cache that corresponds to an ID stored in the ID list field of the row, and increasing the count value of the row.

12. The program product of claim 11, further comprising the steps of: combining rows of said invalidation index that have the count value greater than a predetermined threshold into a new row at a predetermined time; joining ID values in the ID list fields of the rows together into an ID value; calculating a search key corresponding to said ID value generated by joining, and storing calculated search key in the search key field of the new row.

13. The program product of claim 12, wherein said count value increases in increments of one.

14. The program according to claim 13, wherein the step of increasing or decreasing the count value derives a value that is weighted based on numbers of data updates and reference queries for each row of the invalidation index and stores the value as the count value.

15. A system for accessing data in a computing environment having at least one processor, comprising:
a database and a data cache in which data from said database is cached in processing communication with said processor;
said processor being also in processing communication with a memory disposed in said system;
an invalidation index having a plurality of rows each associatable with different queries for data from said memory; said invalidation index accessing data in said memory and database from said data cache;
said invalidation index having a search key field, an ID list field for IDs of records in said database, and a count value field in each of said rows;
a search key created for each invalidation index and disposed in said search key field by said processor when a reference query is received by said processor; said processor extracting a column value from said data base required for creating said search key and creating said search key that relates to said particular invalidation index;
a count value that can be incremented or decreased in response to said processor r searching for existence of a row of invalidation index created for a search key; said processor decreasing said count value in response to finding said row invalidation index for said search key. The system of claim 15 wherein said processor creates a new row in said invalidation index in response to not finding a row of the invalidation index that has a particular key and then stores said new created search key in said search key field of said new row, and subsequently stores a new ID of a record in said database that matches a search condition associated with said reference query in the ID list field of said new row.

16. The system of claim 15, wherein said processor can repeat the search process within an available index size by splitting a row of said invalidation index that has a smallest count value and that has the created search key into new rows at a predetermined time according to a condition relating to record values of the database and then sorts ID values that have been stored in the ID list field of the split row according to the condition relating to the record values

17. The system of claim 16, wherein said processor stores sorted ID values in said ID list fields of said new rows, and stores, in said search key fields of the new rows, different search key values that are calculated based on the ID values that are sorted and stored.

18. The system of claim 17, further comprising: means for creating a search key for the invalidation index based on a search condition portion of an update query.

19. The system of claim 18, further comprising means for, in response to finding a row of the invalidation index that has the created search key, invalidating data in the data cache that corresponds to an ID stored in the ID list field of the row, and increasing the count value of the row.

20. The system of claim 19, wherein said count value increases by increments of one and increasing and decreasing of value is based on a weighted number calculated by said processor based on number of data updates and reference queries for each row of said invalidation index stored as count value, further comprising: means for combining rows of said invalidation index that have the count value greater than a predetermined threshold into a new row at a predetermined time wherein said processor can join ID values in the ID list fields of the rows together into an ID value and means for calculating a search key corresponding to the ID value generated by joining; said processor storing said calculated search key in the search key field of said new row.
